(19) United States
(12) Patent Application Publication
(10) Pub. No.: US 2026/0047973 A1
(43) Pub. Date: Feb. 19, 2026

(54) MICROPROCESSOR CONTROLLED CLUTCHING MECHANISM FOR AFO WITH CARBON FIBER LEAF SPRING

(71) Applicant: The Arizona Board of Regents on behalf of Northern Arizona University, Flagstaff, AZ (US)

(72) Inventors: Zachary F. LERNER, Flagstaff, AZ (US); Riley SHEPARD, Flagstaff, AZ (US); Shanpu FANG, Flagstaff, AZ (US)

(21) Appl. No.: 19/307,483

(22) Filed: Aug. 22, 2025

Related U.S. Application Data
(63) Continuation-in-part of application No. 19/304,465, filed on Aug. 19, 2025.
(60) Provisional application No. 63/684,528, filed on Aug. 19, 2024.

(51) Int. Cl. A61H 1/02; A61H 3/00

(52) U.S. Cl. CPC A61H 1/0266; A61H 3/00; A61H 2003/007; A61H 2201/1207; A61H 2201/1445; A61H 2201/1454; A61H 2201/1642; A61H 2201/165; A61H 2201/5007; A61H 2201/5058; A61H 2201/5069; A61H 2201/5071; A61H 2230/625

(57) ABSTRACT

An assistive ankle support device is described, usable to improve the performance of ankle foot orthoses and exoskeletons. The device has a tubular vertical member arranged medially to a user's limb. The member carries a rotational bearing and a rotational element such as a pulley. The pulley is connected to a footplate. The footplate provides joint movement assistance or resistance to the user upon rotation of the pulley. The pulley is coupled to a leaf spring mounted internally to the tubular vertical member. A clutch mechanism selectively couples the leaf spring to the pulley via a ratchet. The clutch mechanism may be automatically controlled by a controller.

### CROSS-REFERENCE TO RELATED APPLICATIONS

This application is a continuation-in-part of U.S. Patent Application Ser. No. 19/304,465, filed under the same title on Aug. 19, 2025, which claims priority to U.S. Provisional Application 63/684,528 entitled “MICROPROCESSOR CONTROLLED CLUTCHING MECHANISM FOR CARBON FIBER LEAF SPRING” and filed on Aug. 19, 2024, which are incorporated herein by reference in their entirety for all purposes.

### STATEMENT CONCERNING FEDERALLY-FUNDED RESEARCH

This invention was made with government support under Grant No. 2045966 awarded by the National Science Foundation and under Grant No. 1R01HD107277 awarded by the National Institutes of Health. The Government may have certain rights in the invention.

### BACKGROUND

A number of injuries or conditions can lead to disorders that affect muscle control. Individuals with muscle control disorders frequently experience a downward trend of reduced physical activity and worsening of gait function leading to a permanent decline in ambulatory ability. Upper-or lower-extremity orthoses, powered exoskeletons and ankle foot orthoses (AFOs), are commonly prescribed for individuals who suffer from such muscle control disorders, or other impairments, as from stroke, incomplete spinal cord injury and cerebral palsy. These devices provide mobility enhancement by applying assistive joint torque through the gait cycle. Existing devices use a variety of design approaches to accomplish this fundamental aim. These devices may include Bowden cable actuation, direct-drive shank mounted motors, fabric shank interfaces, bilateral carbon fiber frames, and lateral lower leg structures. Certain devices can also be used for training or strengthening aids, by providing active resistance during some or all phases of the gait cycle.

One solution that may be used for individuals who have a substantial level of disability is the powered joint exoskeleton. Examples of such devices can be found in co-owned U.S. Patent Application Publication No. US20210378904A1, entitled “Cable-actuated, Kinetically-balanced, Parallel Torque Transfer Exoskeleton Joint Actuator With or Without Strain Sensing”, published on Dec. 9, 2021. The entirety of that publication is incorporated herein by reference for all purposes. In the aforementioned publication, a powered exoskeleton device is disclosed, as well as several improvements to the device. A powered exoskeleton includes a motor assembly including one or more counterrotating motors. The one or more motors are coupled to a transmission assembly, which may include a pair of Bowden cables, one for each joint to which assistance is being provided (i.e., a user's ankles). The exoskeleton includes a pair of support members, one for each leg, preferably arranged along side the user's lower legs, on the medial sides, and coupled to the legs via calf cuffs. At distal ends of the support members, footplates are arranged below the user's feet. The footplates are rotatably coupled to the support members via rotational bearings such that distal ends of the footplates (in the region of the toes) can rotate up (flexion) and down (extension). A pulley is also coupled to the rotational bearing and footplate, and the transmission assembly (i.e., the Bowden cables) are coupled to the pulley such that the motor assembly can drive the footplate in flexion and extension. A variety of sensors are provided to enable control of the device during use, the sensors may include a pressure sensor at the footplate to measure force being applied by the user between the user's foot and the footplate/ground, angle and speed sensors at the rotational bearing, and torque sensors at the rotational bearing.

Additionally, the aforementioned publication discloses improvements over this basic arrangement. In one improvement, the vertical support members are provided as tubular members, preferably of a light material like carbon fiber. The tubular support members have a closed, fully-boxed cross section throughout their length, and particularly, above and below the interface between the tubular members and the rotational bearing. In some embodiments, the tubular members are configured to permit the pulley to be arranged along a centerline running through the middle of the tubular member. This arrangement greatly increases the rigidity of the design, and prevents flexure and deflection of the pulley and bearing that might otherwise result from the user's weight on the footplate.

While useful, even required under certain circumstances, a full powered exoskeleton of the sort just described has certain disadvantages, including bulk, weight, expense and high-power consumption (i.e., short battery life). Additionally, the level of assistance provided by such devices may not be necessary for many people with relatively minor impairments. In these cases, AFOs may be proscribed instead. An AFO may be a passive support device that provides support (i.e., resistance) to the ankle joint. AFO's may also include energy storage, for example, by providing some mechanical energy storage device (such as a spring) that stores energy during midstance and returns it during the pushoff phase of the user's gait. Additionally, while AFO's are generally simpler and lighter devices than full exoskeleton assistive devices, AFOs may also include active drive components.

AFOs generally include footplates to direct torsional force provided at the angle toward the ground, or additionally alternatively, to resist torsional forces imparted by the user's ankle joint. A footplate is located beneath the user's foot, and between the user's foot and the ground, typically on the foot bed of a shoe worn by the user. In addition to constituting a force transmitting interface between the user's foot and the ground, in the case of active devices, the foot plate typically carries one or more sensors, such as pressure sensors, which may measure the force being applied to the foot plate or the ground by the user of the device.

While AFOs have certain advantages over more elaborate powered exoskeleton devices, (e.g., their smaller size, lighter weight, and passive nature), they also have some disadvantages. Typically, AFOs offer limited adjustability, and they may not be well-suited for dynamic activities like stair claiming. Further improvements are warranted.

### BRIEF SUMMARY

Embodiments of the invention are directed to an improved interface between a vertical support member and a rotatable footplate for use in an AFO or a powered ankle exoskeleton. Embodiments include a mechanical, and optionally, an electro-mechanical clutching mechanism. The mechanism includes a ratchet and pawl system connected to an energy storage device, such as a spring. In certain embodiments the spring is a carbon fiber leaf spring. The clutching mechanism allows a rotating pulley connected to rotate and provide assistive or resistive torque to a footplate to selectably engaged with the energy storage device. In one embodiment, the selective engagement mechanism is a ratchet structure on a rotationally pulley that can be selectively engaged with a pawl arm which, when it is in an engaged position, can interface with a leaf spring. Engagement can be manual or automatic. That is, in one embodiment, a user can flip the pawl from a non-engaged to an engaged position. In certain embodiments, the pawl is biased (e.g., with a spring) in a nonengaged position, and it must be actuated (manually or automatically) into an engaged position. Alternative embodiments are directed to various arrangements for moving the pawl. In one embodiment, the pawl is actuated with a servo motor. In alternative embodiments, the pawl is actuated magnetically. Actuation of the pawl (whether manual, electrical or magnetic) can be user-determined, or it can be automatic and determined by a microprocessor or controller receiving data from one or more sensors.

Embodiments of the invention have certain advantages. For example, an AFO equipped with the disclosed clutching system may transition from a passive support state to an active energy storage and release state depending on various conditions and user activity. For example, in certain cases, the clutching system may engage when a user is walking up stairs. Additionally, by controlling the engagement of the energy storage device with a controller receiving data from sensors (such as a joint angle sensor), an AFO using the disclosed clutching mechanism can adjust the point at which the spring is engaged and the range of angle angular motion over which it is engaged. This may be particularly useful for occasional tasks like climbing or descending stairs.

In one embodiment, an improved assistive device includes an energy storage mechanism that stores energy input by the user when the user rotates an upright member with respect to a footplate (or equivalently, rotates the user's lower leg with respect to the plane of the sole of their foot). In preferred embodiments, the energy storage mechanism is a linear carbon fire leaf spring, which is mounted with its long axis parallel to the upright member, and preferably, within the interior of the upright member. The leaf spring acts as a parallel elastic element, providing additional support and reducing the load on the motor in an exoskeleton or offering dynamic adjustability in an AFO.

In one embodiment, the improved device includes a ratchet and selectable pawl system. This system selectably connects the energy storage device (e.g., the leaf spring) to a pulley aligned with the joint of the user (e.g., the user's ankle joint). The pawl can lock into the ratchet to engage the spring or be disengaged to allow free movement. In preferred embodiments, the pawl is rotatably mounted to the upright member, and can selectably rotate down to engage with a ratchet (i.e., a series of teeth) located on the pulley. Engagement can occur at multiple, selectable positions along the perimeter of the pulley (i.e., along the length of the ratchet section). This means that whether the leaf spring is engaged by pulley rotation, and the rotational state at which engagement occurs are both selectable. This allows selection of the rotational state of the pulley (which is equivalent to the rotational state of the footbed and the user's ankle joint) at which the device starts providing resistance from the spring, and storing energy in the spring, is selectable.

In one embodiment, selective engagement is performed with an automatic actuator. In one embodiment, the device includes a micro servo motor that actuates the pawl. This motor may be controlled by a microprocessor, allowing for automatic adjustments based on user activity. Alternatively, it may be controlled by the user directly. Alternatively, there may be no automatic actuation of the pawl, and the user may directly, physically move the pawl into and out of engagement.

In one embodiment, the device includes one or more microprocessors in electronic data communication with one or more sensors located on the device. The sensors preferably include a pressure sensor located beneath the user's foot on the footbed, a joint angle sensor to measure the degree of rotation of the pulley (which is equivalent to the angle between the plane of the footbed and the upright member), and a joint speed sensor, which measures the rotational velocity of the pulley (i.e., the ankle joint). The microprocessor is preferably in electronic data communication with non-volatile data storage (i.e., a memory), that stores computer readable instructions that, which are executed by the processor, cause the processor to control the device in accordance with method steps set for this description. Preferably, the microprocessor controls both actuation of a motor that drives the footbed, and the actuator of the pawl (e.g., the servo motor) or other device that selectively engages the spring to the pulley. In certain embodiments, the microprocessor is located at the device, but in other embodiments, the device includes a controller and/or a network data communication interface (e.g., a Bluetooth or Wi-Fi adapter) that enables communication between sensors and actuators on the device and a remote microprocessor. In these cases, the controlling microprocessor may be a microprocessor located on a remote computer such as a smart phone.

In other embodiments of a leaf spring engagement clutch, rather than driving a pawl directly with a motor, the pawl is driven by a spring-loaded, servo-actuated magnetic engagement mechanism, which also may be controlled by a microprocessor. To engage the clutch, the servo motor moves the magnet away from the pawl, which immediately rotates towards ratchet, aided by a small rotary spring to minimize engagement time (maximize pawl-ratchet engagement speed). To disengage the leaf-spring, the servo motor actuates the magnet to a position above the pawl (to a location that elicits sufficient magnetic attraction to overcome the force of the small rotary spring), pulling the pawl away from the ratchet, disengaging the clutched leaf spring.

In one embodiment, the disclosed devices improve the energy efficiency of powered ankle exoskeletons. The disclosed devices use a clutched parallel elastic member (leaf spring) to store elastic energy during ankle dorsiflexion of early stance phase in order to offload exoskeleton's primary actuators when providing plantar flexor assistance during mid to late stance phase. The leaf spring interfaces with the pulley using a ratchet and pawl mechanism. The pawl is mounted to the end of the leaf spring using a bracket that allows the pawl to pivot up and down. Using a torsional spring, the pawl is tensioned upwards to have clearance between the teeth of the ratchet. A micro servo motor is mounted to the upright with an arm that rotates to push the pawl downwards to engage with the teeth on the pulley. This acts as a clutch to engage the leaf spring with the pulley which rotates with the ankle joint. In one embodiment, a powered exoskeleton may use a brushless DC motor (e.g., Maxon, Cubemars, etc.) to provide a torque assist at the ankle using a direct drive or transmission (e.g., through a chain and/or steel cable and/or belt-drive transmission system) configuration. When the leaf spring clutch is engaged, the torque generated by the deflection of the leaf spring reduces the amount of torque needed by the exoskeleton's primary motors (acting through the transmission system) when attempting to achieve the target setpoint for stance phase plantar-flexor assistance. This may result in an increase in operational run-time of the device by reducing battery consumption and/or reduce the size requirement of the exoskeleton's primary actuators.

Embodiments of the invention have certain advantages. By selectively engaging an energy storage mechanism, the device can be configured to store and release energy developed during a user's gait in one mode, but in another mode, allow the device to swing freely. When the device is storing and returning energy, the load on a driving motor, if being used, can be decreased. Additionally, the device can select the rotational state of the ankle at which energy storage/resistance is applied. Additionally, the device can provide resistance during some stages of the gait, then disconnect the spring during other stages. This manner of use may be advantageous when a user is descending stairs, for example.

Generally, the device modifications described herein are usable to optimize performance across different ambulatory conditions. Devices according to inventive embodiments may be used both for AFOs (both passive and active) as well as for more elaborate exoskeleton devices. Additional advantages will become clear upon consideration of the detailed description of the preferred embodiments taken in conjunction with the accompanying drawings.

### BRIEF DESCRIPTION OF THE DRAWINGS

The drawings described herein constitute part of this specification and include exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 depicts an embodiment of a powered or passive AFO having an internally mounted leaf spring.

FIG. 2 depicts an improved embodiment of a powered or passive AFO including a clutching mechanism using a servo motor.

FIG. 3 depicts an alternative improved embodiment of a powered or passive AFO including a clutching mechanism using magnetic actuation.

### DETAILED DESCRIPTION OF THE PREFERRED EMBODIMENTS

The described features, advantages, and characteristics may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment. References to “users” refer generally to individuals accessing a particular computing device or resource, to an external computing device accessing a particular computing device or resource, or to various processes executing in any combination of hardware, software, or firmware that access a particular computing device or resource. Similarly, references to a “server” refer generally to a computing device acting as a server, or processes executing in any combination of hardware, software, or firmware that access control access to a particular computing device or resource.

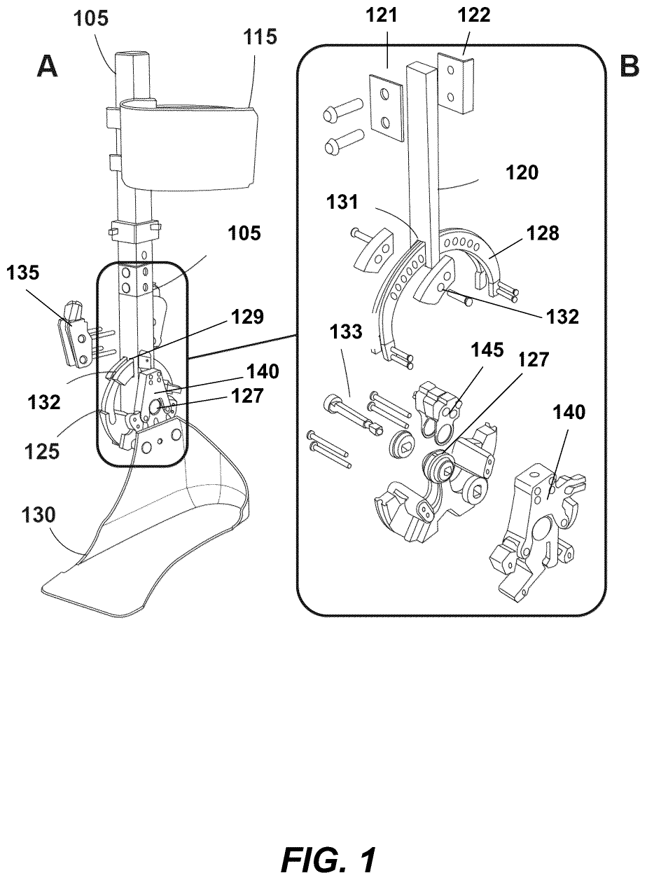

For purposes of description herein, the terms “upper,” “lower,” “right,” “left,” “rear,” “front,” “vertical,” “upright,” “horizontal,” and derivatives thereof shall relate to the embodiment of the invention as oriented in FIG. 1. However, it is to be understood that the invention may assume various alternative orientations, except where expressly specified to the contrary. It is also to be understood that the specific devices and processes illustrated in the attached drawings, and described herein are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily a detailed design, and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if any assembly or composition is described as containing components A, B, and/or C, the assembly or composition can contain: A alone; B alone; C alone; A and B in combination; A and C in combination; B and C in combination; or A, B, and C in combination.

As used herein, the terms “assistance” and “resistance” may be used interchangeably to signify the direction of external torque applied to a joint that may be perceived as augmenting (making a movement easier, assistance) or harder (resistance).

The following disclosure relates, inter alia, to an AFO comprised of a footplate component, an “upright” component that mounts laterally to the lower limb, a hinge mechanism located in line with the ankle joint, and a calf attachment point. The footplate is interchangeable and can be swapped out for different sizes. The calf attachment component could be a “calf cuff” or “shin cuff” that incorporates a rigid or semi-rigid shell with a soft (e.g., foam) lining; the calf attachment can be adjust up or down the limb and be interchanged for different sizes. The upright may be comprised of a rigid carbon fiber circular, oval, rectangular, hexagonal, square or other polygonal tube. The hinge mechanism may incorporate a pulley, cam, sprocket or a combination of these placed within the upright tube that rotates relative to upright through bearings or bushings. The lateral upright design may incorporate quick release features and component modularity of the design allows the AFO to grow with a child. In some configurations, mounted within or outside of the upright, are spring components that may include linear extension springs, linear compression springs, leaf springs (e.g., elastic carbon fiber bar), linear, non-linear, or constant force rotary springs.

The AFO may include different joint stiffness components (e.g., a linear, compression, rotary, or leaf spring) for the plantar-flexion direction (pointing toes downward) and the dorsi-flexor direction (pointing toes upward), so that the plantar-flexor direction is stiffer than the dorsi-flexor direction. In an assistive configuration, a spring component may be engaged such that the AFO resists extension during the stance phase and/or resists flexion during the swing phase. In a resistive configuration, a spring component may be engaged such that the AFO resists plantar-flexion during the stance phase and/or resists dorsi-flexor during the swing phase. The AFO may have adjustable plantar-flexor and dorsi-flexor equilibrium angles.

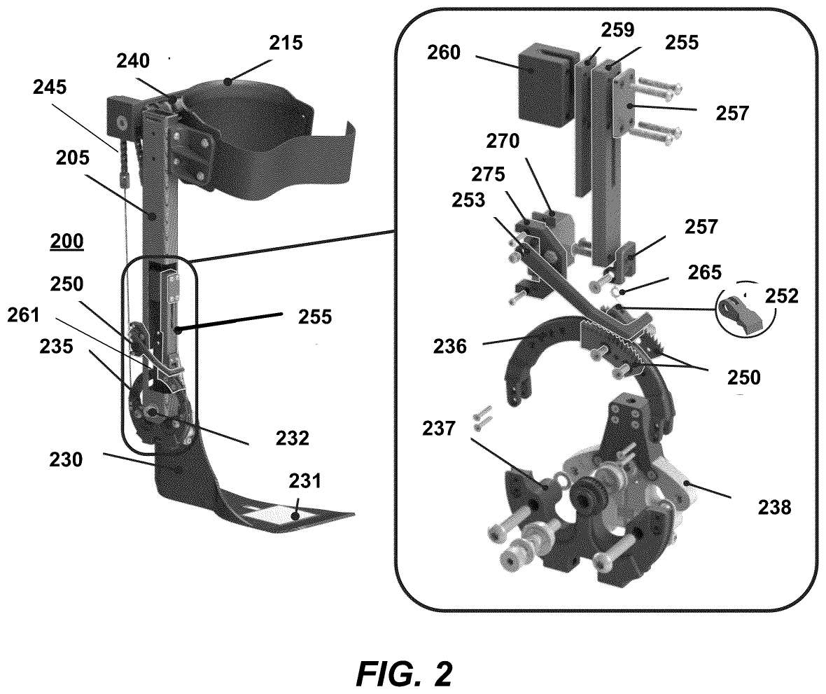

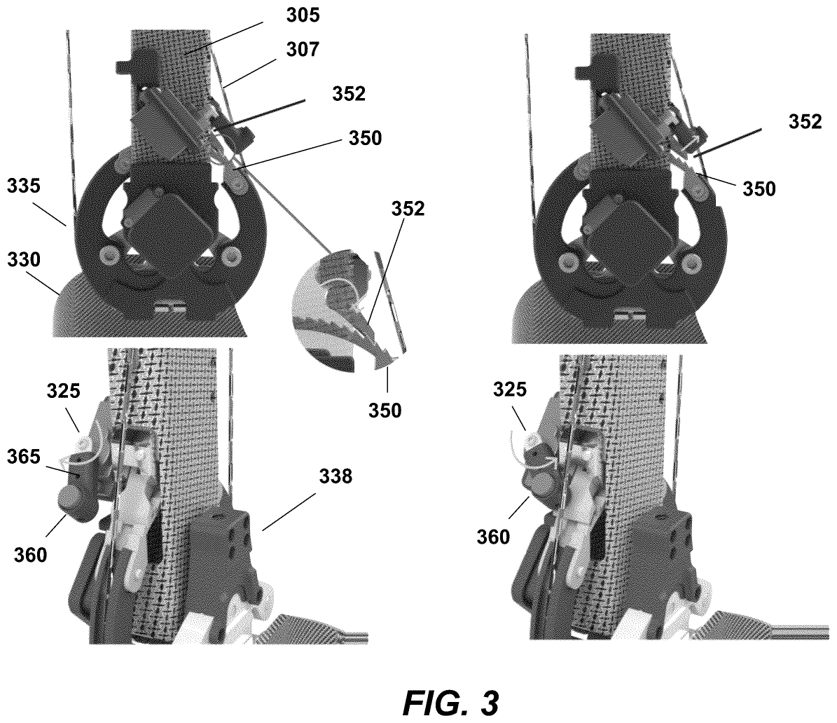

An AFO incorporating a leaf spring will now be described in connection with FIG. 1 as a means of illustrating certain basic components of an AFO incorporating a leaf spring for energy storage during various gate stages. The AFO of FIG. 1 may be improved by the clutching mechanism that will be described further below in connection with FIG. 2-3. Although the disclosure set forth below in FIGS. 1-3 refers generally to active (i.e., powered or motorized) or passive AFOs, this is not limiting and the invention is equally applicable to improve powered exoskeleton of the sort disclosed in U.S. Patent Publication No. US20210378904A1. Additionally, the embodiments below are usable in connection with other AFO designs such as the designs incorporated in U.S. Pat. No. 12,133,811, entitled “Differential and Variable Stiffness Orthosis Design With Adjustment Methods, Monitoring and Intelligence,” the entirety of which of is incorporated by reference herein for all purposes.

Referring now to FIG. 1, there is shown a passive assistive AFO using a leaf spring as an energy storage device. The device of FIG. 1 includes a hollow, upright member 105, which is preferably tubular (i.e., having a closed circumferential cross section along at least most of its length, and in particular, in the vicinity of the rotational bearing to be described.). Preferably, the upright member is made of carbon fiber, but other materials such as steel, aluminum, titanium, fiberglass or thermoplastic are usable. Medially projecting from upright member 105 is a user attachment device 115, such as a calf cuff. Inside the member is mounted a vertically arranged leaf spring 120 (e.g., an elastic carbon fiber bar), which is mounted at a proximal end to an inside wall of member 105. Mounting can be done with a stand-off block 122, a cover 121 and fasteners as illustrated in the magnified portion of the figure denoted as “B”. The device includes a footplate 130, coupled to a pulley 125, which rotates with a rotational bearing 127 mounted through side walls of the member 105, such that the side surfaces of the pulley are within the member side walls. An upper portion 128 of the pulley 125 may be optionally removable, and this portion passes in a slot or aperture 129 in the member 105. The upper portion of the pulley 125 also passes through a slot or aperture in the leaf spring 120 at position 131. This slot or aperture has a width that clears the width of the upper portion of the pulley, but does span the entire width of the anterior and posterior surfaces of the spring 120. This will allow for an interference to occur between stops 132 and the leaf spring 120, as will be discussed below. The pulley 125 includes a rotational bearing 127 that rotates around axle pin 133, which is secured by and between medial and lateral walls of the member 105.

In certain embodiments, the components illustrated in FIG. 1 are part of a powered device, where a pair cables, e.g., Bowden cables, are coupled to the pulley to provide powered dorsi and plantar extension assistance. In such cases, these cables will be coupled to a non-illustrated battery powered motor that can provide tension and therefore rotation and counter rotation to the pulley. In these embodiments, the device may include a pair of Bowden cable tensioners (e.g., 135) to which the sheaths of the Bowden cables are mounted. The tensioners may include barrels that allow the tension between the sheaths to be varied with respect to the inner cables. In active devices the footplate 130 may be attached to the pulley 125 via an optional strain sensor and mounting block 140, which may be useful for data collection and computing desired supplied power ankle torque. In alternative passive embodiments, the footplate may mount directly to the pulley without an intervening sensor block. Active or passive devices may also include other sensors, such as an angle encoder 145 or other angle position, velocity, or acceleration sensor, and one or more pressure sensors on the footbed. Additionally, footplate 130 may carry one or more pressure sensors to measure the force applied by the user to footplate.

In the device of FIG. 1, one or more stop assemblies 132 may be affixed to the pulley 125 at a variety of positions along the pulley's perimeter. In one case, there are a number of fixed positions the stop assemblies can occupy, but alternatively, the stop assemblies could be slid along continuously and fixed at a continuum of positions, using a tensioning mechanism. Fixed positions may be preferable because the stop assemblies must resist a large amount of shearing force in operation. The positions of the stop assemblies along the pulley determine the angular position of the pulley at which the leaf spring 120 is engaged and deflects. Referring now to stop assembly 132, as the footplate pictured is rotated into a more toe-up position, the leaf spring will be engaged and will store energy, which will be returned as the foot is rotated back down. Another stop assembly on the anterior side of the leaf spring will perform the same function for toe-down rotation. By adjusting the positions of the stops, the angles at which resistance begins can be changed. Assistance and resistance provided by the leaf spring 120 can be removed entirely by removing the stop assemblies.

While the design depicted in FIG. 1 is adjustable, adjustability requires that the user manually remove, adjust, and reinstall the stop assemblies. This is a cumbersome process, and the FIG. 1 design does not permit dynamic adjustments to be made during various gait stages. That functionality is provided by the designs described in reference to FIGS. 2 and 3, which will now be described.

Referring now to FIG. 2, there is shown an improved AFO device including functionality to selectably engage an energy storage device, in this case a leaf spring. FIG. 2 shows an AFO 200. The AFO may be passive (i.e., not providing motorized assistance) or passive (i.e., providing mechanical support by not motorized assistance). In the example of FIG. 2, the AFO 200 is active. The AFO includes an upright member 205. Member 205 may be steel, aluminum, titanium, carbon fiber, fiberglass, thermoplastic or any other suitably strong and stiff material. Member 205 may be a flat bar, angle iron, c-channel or fully boxed. In the example of FIG. 2, member 205 is a fully boxed, tubular member, having a closed circumferential cross section along almost all of its length, including, above and below an aperture at a distal end of the member for receiving an axle that will enable rotation of a coupled footplate. In the embodiment of FIG. 2, member 205 has a rectangular cross section, with first and second opposing and mutually parallel sidewalls, and third and fourth opposing mutually parallel sidewalls, where the angle between adjacent sidewalls is 90 degrees. Other forms of tubular members are possible, such as members with a circular, ovoid, triangular, square, pentagonal, hexagonal, etc.

Near a proximal end of member 205 is a laterally mounted calf cuff 215, that may include a relatively rigid but padded, posterior calf-engaging portion. This portion may be made of carbon fiber, fiberglass, thermoplastic, etc., preferably covered with a foam coating or some other conformable material such that it can be comfortably worn against the skin. An anterior portion of calf cuff 215 may include a strap system, preferably including hook-and-loop material, for strapping the AFO to the lower leg of the user.

At a distal end of member 205 is located a rotatable footplate 230, shaped and sized to engage with the bottom of a user's foot. Footplate 230 is arranged to project laterally from member 205, in the same direction as calf cuff, which results in member 205 being mounted on the medial side of a user's leg or legs, assuming that the user is using a pair of mirror image AFOs of the sort shown in FIG. 2. Footplate (also referred to as a foot bed or footbed) is rotatably coupled to member 205 by a rotational bearing 232 including an axle. Rotational bearing 232 is received through a pair of apertures in member 205, and defines an axis of rotation that is perpendicular to first and second sidewalls of member 205, and is parallel to third and fourth sidewalls of member 205. Preferably, where member 205 is tubular, member 205 has a closed circumferential cross section both above and below the apertures that receive the bearing. This makes member 205 still in the vicinity of rotational bearing 232 and helps member resist deflection from the user pushing on the footplate.

Rotational bearing 232 may carry a pulley 235 to which the footplate 230 is mounted. Pulley 235 may be a circular pulley (constant radius) or cam pulley (non-constant radius) such that the radius may or may not be constant on the flexion or extension rotational directions. In one embodiment, the variation of radius with angle is different on one side of the pulley versus the other side (such that the pulley does not have symmetry about its centerline). Pulley 235 is preferably arranged such that it is on a centerline of the member 205. Because the outside diameter of pulley 235 will generally exceed the outside diameter of the tubular member, member 205 may include a pair of apertures through which an upper portion 236 of pulley 235 can pass, in a manner similar to that shown in FIG. 1. Upper portion 236 may also be removable from pulley 235, and/or may include a removable segment to make installation of the pulley easier. A lower portion 237 of pulley 235 is coupled to the footplate 230 (i.e., the footplate 230 is coupled to the lower portion 237 of the pulley). In the preferred embodiment of FIG. 2, the footplate 230 is mounted directly to a mounting block 238 which may be useful for data collection and computing desired supplied power ankle torque. In alternative passive embodiments, the footplate may mount directly to the pulley without an intervening sensor block. Active or passive devices may also include other sensors, such as an angle encoder (not illustrated), which may measure both the rotational position of the pulley and its rotational velocity, and/or other angle, position, velocity, or acceleration sensors. Additionally, the FIG. 2 embodiment includes a pressure sensor 231 located under a user's foot on the footplate 230 for measuring the amount of force the user is exerting on the footplate.

AFO 200 may optionally be active, in that it actively applies resistance or assistance in terms of ankle torque for a user wearing the device. In the case where the device is active, a controller controlled motor 240 is provided, preferably at a proximal end of the device. Motor provides rotation and counter rotation, and its output shaft is preferably coupled to a sprocket which engages a chain, another sprocket, a network of gears, or some other transmission mechanism. Chain may provide alternating tension (depending on the rotational direction of the motor) to a pair of cables 245, which run from the chain to each side of the pulley 235. Thus, when motor 240 rotates in a first direction, the footplate 230 is rotated in a toe-up direction (providing flexion assistance), and when motor 240 rotates in a second direction, the footplate 230 is rotated in a toe-down direction (providing extension assistance).

The magnified insert in FIG. 2 shows in detail components of an improved selectable energy storage system for the device of FIG. 2. The device includes a ratchet or toothed portion 250 of the upper, or sheave portion 236 of pulley 235. In one case, a set of teeth may be machined or otherwise arranged directly in or on upper portion 236. In a preferred arrangement one or more attachments 250 are provided that can be fastened to the pulley at various places along its circumference. The extend and angular position of the ratchet portion can vary. In the pictured embodiment of FIG. 2, the ratchet section covers 45 degrees of the circumference of the pulley, and has 16 teeth. In the FIG. 2 embodiment ratchet section 250 is realized by two plates with ratchet teeth that are fastened to outside (medial and lateral facing) faces of the upper portion of the pulley. In a preferred arrangement, the ratchet teeth are biased to provide engagement with a pawl 252 in one rotational direction (i.e., pawl 252 may push and be pushed by the pulley when the pulley rotates in a toe-up direction, but pulley will slip with respect to pawl 252 when the pulley is pulled in a toe-down direction). The bias may be reversed in some cases, and in other cases, the tooth profile on section 250 may be symmetrical (e.g., a square tooth or symmetrical triangle profile), to provide equal engagement with pawl 252 in both rotational directions. Engagement between the ratchet section and the pawl is provided by the pawl's distal end, which has a rightward facing beak section having an approximately triangular cross section.

Pawl 252 is rotatably coupled to an energy storage device, specifically, a leaf spring 255, although other storage devices such as a compression spring, or a ratcheting rotary spring coupled directly to the rotational bearing or pulley are also acceptable. Leaf spring 255 has a long dimension and transverse short dimensions, and is preferably arranged such that its long dimension is parallel to the long dimension of the upright member 205. Leaf spring 255 may be steel, aluminum, titanium, fiberglass or thermoplastic, but in the preferred embodiment is a carbon fiber bar having a rectangular short cross section. Leaf spring 255 may be arranged laterally, on an outside surface of the tubular upright member 205, but in preferred arrangements, is arranged inside of member 205, i.e., within the volume defined by upright members four vertical sidewalls.

Leaf spring 255 is fastened to the posterior facing surface of the front or anterior wall of member 205. In certain cases, it will be helpful to include a load plate 257 on the anterior or outward facing service of the anterior wall of member 205 to spread the forces from fasteners and to provide additional reinforcing strength to the member wall. A block 260 is arranged between the anterior facing surface of the posterior wall of member 205 and the leaf spring 255. Block 260 supports the leaf spring and provides a pivot point around which the leaf spring can deflect when it is loaded in the posterior direction. The leaf spring assembly may also include a supplemental leaf spring 259 (another carbon fiber bar with a rectangular cross section) to provide further stiffness when the spring 255 is deflected in the posterior direction. Preferably, the thickness of block 260 is chosen such that the stack of leaf spring 255, supplemental spring 259 and the block 260 completely fills the space of the interior of the member 205 from anterior to posterior wall.

The member 205 may include one or more apertures or cut outs to accommodate the backwards deflection and forwards return of the spring 250. For example, a long slot 261 may be placed in the posterior facing sidewall of the member to accommodate the posterior deflection of the block 260, as well as to accommodate the passage of the upper part (sheave) of the pulley. Another slot may be provided in the anterior sidewall of the member 205 to accommodate spring back movement of the spring, and especially, to accommodate the mounting bracket for the pawl.

As noted above, in an active device, a motor 240 may alternatively provide tension to a pair of cables coupled to the sides of the pulley sheave. The cable running from the chain to the anterior side of pulley sheave 236 may be routed inside the member 205. This is necessitated by the motor being mounted on a posterior side of member 205 and the fact that the pulley should preferably be centered within the member 205. Thus, one of the cables will run back-to-front, diagonally, through the middle of the member, and apertures/slots may be provided in the anterior and posterior sidewalls of the member 205 to accommodate this front cable. In these cases, leaf spring 255 may include a vertical slot to accommodate passage of the cable. Supplemental spring 259 is helpful in these cases to reinforce spring 255 and provide additional stiffness and support.

At a distal (lower) end of spring 255 is a pawl mounting bracket 257. Pawl mounting bracket includes loops that enable it to receive a pin that attaches pawl 252 to bracket 257 in a manner that enables pawl 252 to rotate up and down (about an axis that runs transverse to the sidewalls of member 205). A spring 265 is arranged between bracket 257 and pawl 252 (i.e., with one leg in each part) to bias the pawl in an upward, non-engaged orientation.

In the FIG. 2 embodiment, a moveable arm 253 is arranged to rotate pawl 252 down from an upper non-engaged position to a lower engaged position. A proximal end of the arm 253 is mounted to the output shaft of a micro servo motor 270, which is arranged so that its output shaft is transverse to the lateral sidewall of the member 205. Servo motor 270 may be mounted to the anterior wall of the member 205, or it may be mounted to a mounting bracket 265, which is mounted to the outside surface of the lateral wall of member 205. Arm 253 is arranged to extend along the lateral sidewall of the member 205, and includes a laterally projecting finger that reaches across the front of the anterior sidewall, where it can come down on top of the pawl 252 to rotate it down.

Referring now to FIG. 3, there is shown an alternative clutch design for an assistive ankle device. The device of FIG. 3 shares many of the same components as those of FIGS. 1 and 2. The device of FIG. 3 includes an upright member, which may be like the embodiments set forth above, but as pictured, is a tubular, carbon fiber member 305 having a rectangular cross section (as above, with an anterior, posterior, lateral and medial sidewall). The member carries a pulley 335, which is rotatably mounted via a rotational bearing including an axle to the member. The pulley 335 is coupled to a mount 338, which may carry a strain sensor to measure ankle torque. The other sensors described above in reference to FIGS. 1 and 2 may also be present in the device of FIG. 3. The mount 338 is coupled to a footplate 330, which can rotate with the pulley relative to the upright member 305. The footplate (at the distal end of member 305) projects laterally, as does the non-illustrated calf cuff, which is located at the proximal end of the member 305. The device carries a motor, which alternatively tensions cables 307 to rotate the footplate, thereby providing resistance or assistance. The member 305 includes a leaf spring assembly as in FIG. 2 (i.e., the leaf spring assembly is mounted within the member, and the member and the leaf spring may contain slots or apertures to allow for deflection of the leaf spring, passage of the upper portion of the pulley, and passage of the cables.

In the embodiment of FIG. 3, as in the embodiment of FIG. 2, an upper portion of pulley 335 includes a ratchet portion 350 of teeth or serrations. In the FIG. 3 embodiment, ratchet portion 350 may define an upper, partially circular portion of the pulley 335, and may be removable such that it can act as a gate to allow the pulley 335 to be installed through the apertures in member 305. The device of FIG. 3 also includes a rotatable pawl 352, rotatably mounted to the member 305 and configured to selectably engage the teeth of the ratchet 350, as in FIG. 2. The engagement of pawl 352 and ratchet 350 through the beaked distal end of the pawl is evident in the inset, magnified portions of FIG. 3. Pawl 352 is mounted to member 305 with a hinged connection, and a spring is coupled to both parts to bias the pawl in a downward or engaged direction, as shown on the left-hand side of FIG. 3.

The device of FIG. 3 differs from the device of FIG. 2 in that it uses a magnetic mechanism to disengage the pawl 352 from the ratchet 350. The device includes a motor, 325, which is mounted on the outside of the medial side wall of member 305. The motor's output shaft is coupled to a swing arm 365, such that actuation of the motor in a first direction will cause the swing arm to rotate down toward the pulley and actuation of the motor in a second, opposite direction will cause the swing arm to rotate up away from the pulley. The distal end of the swing arm includes one or more magnets, which may be passive (e.g., strong neodymium magnets) or active (e.g., an electro magnet). In an engaged mode, the swing arm is swung down, where the magnet is positioning over the pawl, and in this position, the pawl is attracted to the magnetic, and rotates up (against the biasing force of the spring) toward, and preferably to contact with, the magnet or swing arm. In this way the pawl is disengaged, and the leaf spring is not deflected by the pawl. This is shown in the right-hand-side of FIG. 3. In an engaged position, the swing arm is moved up and away from the pawl, and contact with pawl is broken, and the spring biases the pawl down and into contact with the ratchet. This is shown in the left-hand-side of FIG. 3.

The devices described above have certain advantages over conventional AFOs and other assistive devices. The provision of a passive spring element (i.e., the leaf spring) enables the device to provide resistance to the user during certain gait stages by deflecting the spring and storing energy, which energy is then returned during other gait stages. A human gait cycle may be divided into two parts: stance and swing. The stance phase is when the foot is on the ground, and the swing phase is when the foot has left the ground and is being moved forward for the next stance phase. Stance phase starts with a heel strike, when the foot's heel makes contact with the ground, ending the previous swing phase. After heel-strike is early stance. During early stance, the ankle angle is increasing (called extension) as the person rotates the foot to place it flat on the ground. Midstance begins when the person's weight is placed entirely on the stance foot, the foot is flat on the ground, weight is distributed roughly equally between heel and ball, the bottom of the foot makes an approximately 90 degree angle with the leg, and the person's weight is shifting forward. In terminal or late stance, a person's lower leg rotates over the foot, the angle between the leg and foot decreases (called dorsiflexion), weight is shifted to the ball of the foot, and the heel comes off the ground. The stance phase ends at pushoff, when the person drives the ball of the foot into the ground (extension of the ankle), and lifts the foot. It is at this stage, where the ankle is engaged in extension and is pushing the front of the foot into the ground, where assistance from assistive devices is typically needed the most. The devices described above may be configured to engage the spring during dorsiflexion (during the first part of late stance, as the leg is rotating over the foot), to store energy. The energy is released as the person engages in extension during the latter part of late stance, as the ball of the foot is being driven into the ground. This arrangement increases efficiency and offloads the energy required by motors to the leaf springs.

Additionally, because the engagement of the leaf spring is selectable, this energy storage and return arrangement can be essentially turned off. A user might disengage this functionality for rehabilitation purposes, to build strength in extension, or they might only engage it during particular sorts of more demanding activities, like walking up stairs or running.

As is noted above, the device of FIGS. 2 and 3 is preferably used in conjunction with a microprocessor, which may be operating in a computing environment such as laptop, desktop or smart phone. In these arrangements, the computing device will have the elements typically associated with computing devices, for example, in addition to the processor, volatile and non-volatile memory and storage, input/output devices such as keyboards, mice, touch screens, microphones, speakers and displays, wireless and wired network communication devices such as WiFi, Bluetooth and Ethernet interfaces, and other infrastructure like power supplies and internal communication buses. The non-volatile storage may store computable readable and computer executable instructions operable to cause the processor to control various elements of the device, like the assistive motor driving the footplate, and the micro motor driving the pawl.

By automatically controlling actuation of the pawl, and engagement of the leaf spring, with a microprocessor or controller, additional advantages can be achieved by engaging or disengaging the spring in accordance with predefined algorithms executed by the processor described above. For example, by tracking and angle ankle with an angle encoder at the rotational bearing, as well as other sensor outputs like an output from the footplate force sensor (e.g., a force sensitive resistor), the gait stages can be tracked. Essentially, this process would involve determining stance versus swing on the basis of the FSR reading (where a reading above zero indicates the foot is on the ground), and then looking for patterns in the rotational movement of the angles, as well as increases and decreases in the footplate force, to determine where the foot is in the stance phase. With this data, the microprocessor can automatically engage the leaf spring only during early-stance, just as the leg is being rotated over the foot. This would allow the user to load the spring during mid-stance up until early late-stance, such that the spring could return the stored energy during push off. Then, once push off was detected (e.g., by an increase in the ankle angle above some threshold combined with a low reading on the FSR indicating that the toe had come off the ground), the leaf spring can be automatically disengaged during swing phase so that the foot could be freely rotated up (in dorsiflexion) in preparation for heel-strike.

Additionally, other sensors can be part of this process. For example, gyroscopic sensors and accelerometers could be used to determine phases of gait (i.e., heel strike, early stance phase, mid-late stance phase, and swing phase) to selectively engage and disengage the clutched leaf spring.

A variety of sensors could also be used to detect when the user was engaged in demanding tasks like climbing stairs or running. Detection of these sorts of activities can be used to automatically trigger engagement of the leaf spring, during the appropriate portion of the gait cycle, and then the leaf spring could remain disengaged during normal walking.

Control of leaf-spring engagement (early stance) and disengagement (late stance/early swing) may be based on thresholds from sensors, like force, pressure, or acceleration sensors. Engagement timing may be further optimized using human-in-the-loop optimization techniques. These human-in-the-loop techniques monitor a performance metric (e.g., muscle activity, metabolic energy measurement, spatiotemporal parameters of gait, etc.), and adjust leaf-spring engagement timing using real-time optimization algorithms to converge on a global minima for the selected performance metric.

The exemplary embodiments described above have been AFO's or orthoses that provide assistance or resistance to a user's ankle. A person of ordinary skill will appreciate that the teachings of this disclosure are equally applicable to other joint orthoses such as orthoses for wrists, knees and elbows.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

It is also important to note that the construction and arrangement of the elements of the invention as shown in the examples are illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment.

The exemplary structures disclosed herein are for illustrative purposes and are not to be construed as limiting. In addition, variations and modifications can be made on the aforementioned structures without departing from the concepts of the present invention and such concepts are intended to be covered by the following claims unless these claims by their language expressly state otherwise.

The invention claimed is:

1. A wearable assistive device, comprising:
an extended, structural member having a first end and a second end defining a long axis;
an attachment device coupled to the extended, structural member and extending laterally from the member, the attachment device configured to secure the member to a limb of a user;
a rotational bearing disposed within the extended, structural member and positioned on the long axis near the second end of the extended, structural member;
a pulley coupled to the rotational bearing;
a footplate dimensioned to support a foot of a wearer of the assistive device and coupled to the pulley such that it may rotate with respect to the long axis of the extended, structural member;
a ratchet arranged on the pulley;
a leaf spring having a long dimension, mounted to the extended, structural member, and arranged such that the long dimension of the leaf spring is parallel to the long dimension of the extended, structural member when the leaf spring is relaxed;
a pawl moveable between an unengaged position and an engaged position, the pawl coupled to leaf spring;
wherein in the engaged position, the pawl engages the ratchet when the pulley rotates in a first direction causing the leaf spring to deflect in a first direction, and
wherein in the unengaged position, the pawl does not engage the ratchet over a complete range of the pulley's rotational movement.

2. The device of claim 1, further comprising an assistive rotational motor having an output shaft coupled to provide alternating tension to a first cable and a second cable end, and wherein the first and second cable ends are coupled respectively to a first and second sides of the pulley.

3. The device of claim 1, wherein the ratchet is arranged on an upper portion of the pulley.

4. The device of claim 1, wherein the ratchet comprises teeth biased to engage the pawl when the footplate is rotated in a toe-up direction.

5. The device of claim 1, wherein the pawl is manually moveable by a user of the device between the engaged and unengaged positions.

6. The device of claim 1, wherein the pawl is coupled to a spring configured to bias the pawl in one of the engaged or unengaged positions.

7. The device of claim 1, wherein the pawl is coupled to an actuator configured to move the pawl between the engaged and unengaged positions.

8. The device of claim 7, wherein the actuator is a motor coupled to an arm arranged to contact the pawl and rotate it from the unengaged to the engaged position.

9. The device of claim 8, wherein the motor is coupled to an outside surface of the extended, structural member.

10. The device of claim 7, wherein the actuator is a motor coupled to an arm having one or more magnets in the arm's distal end, and wherein the actuator and arm are configured such that the actuator can move the arm from a first position where the magnet is distant from the pawl to a second position where the one or more magnets are sufficiently proximate to the pawl such that the pawl is magnetically engaged and moves from the engaged position to the unengaged position.

11. The device of claim 1, wherein the leaf spring is a carbon fiber leaf spring having a rectangular cross-section.

12. The device of claim 1, wherein the ratchet comprises a moveable gate on a perimeter of the pulley, that may be moved from a closed to an open position creating a gap in the perimeter of the pulley.

13. The device of claim 1, further comprising a joint angle sensor and a pressure sensor located on a dorsal side of the footplate.

14. The device of claim 13, further comprising a programmable processor in electronic data communication with non-volatile memory including computer readable and executable program code operable to cause the processor to receive data reflecting measurements taken by one or both of the joint angle sensor and the pressure sensor and determine, based on the received data, a gait condition of a user using the device.

15. The device of claim 14, further comprising computer readable and executable program code operable to cause the processor to actuate the pawl on the basis of the determination of a gait stage of a user using the device.

16. The device of claim 15, wherein actuating the pawl on the basis of the determination of a gait stage of a user using the device comprising engaging the pawl during dorsiflexion by midstance and disengaging during the swing phase.

17. The device of claim 13, further comprising a programmable processor in electronic data communication with non-volatile memory including computer readable and executable program code operable to cause the processor to receive data reflecting measurements taken by one or both of the joint angle sensor and the pressure sensor and determine, based on the received data, an activity of a user using the device, and on the basis of the determination of an activity, control actuation of the pawl.

18. The device of claim 1, wherein the extended, structural member is tubular, having a closed circumferential cross section over a majority of its length.

19. The device of claim 18, wherein the leaf spring is mounted inside an interior volume of the extended, structural member.

20. The device of claim 19, wherein the leaf spring includes a vertical slot to permit passage of a drive cable coupled between a drive motor and the pulley.
